(19) United States
(12) Patent Application Publication
(10) Pub. No.: US 2003/0103352 A1
(43) Pub. Date: Jun. 5, 2003

(54) Hand-waving illuminant circlet

(75) Inventor: Hui-Nan Yu, Taoyuan (TW)

Correspondence Address: BRUCE H. TROXELL, Suite 1404, 5205 Leesburg Pike, Falls Church, VA, 22041, US

(73) Assignee: TSAI, Jao-Hsing

(21) Appl. No.: 10/002,205

(22) Filed: Dec. 5, 2001

(51) Int. Cl. F21S 8/00; F21V 1/00

(52) U.S. Cl. 362/287; 362/427; 362/422; 362/423

(57) ABSTRACT

A hand-waving illuminant circlet employed as a sports appliance, mainly comprising a cylindrical collar, a rotary hub and at least a loaded illuminant element. The cylindrical collar fastens a handle at its inner rim and holds a ring gear at its outer perimeter. The rotary hub comprises a pair of symmetric disks for eccentric rotation. The inner perimeter of the disks forms a clamp rail for the ring gear to rotate along. The loaded illuminant element comprises two illuminant wheels and a spur gear going between. The spur gear meshes on the ring gear. When the player waves the circlet, the eccentric rotation generated in the rotary hub produces a centrifugal force causing the illuminant element to circumnavigate along the ring gear; besides, the illuminant element produces a fantastic glare providing great fun in practice.

### FIELD OF THE INVENTION

The present invention relates to a hand-waving illuminant circlet, in particular one with simple construction and ease to play. In the meantime, it continues rotating by the moment of inertia and produces a fantastic glare for great fun.

### BACKGROUND OF THE INVENTION

It is well known that there are numerous leisure sports available, among which the gymnasium is very popularly welcome. Nevertheless, the key purpose to practice in the gymnasium or in home is to maintain a good health in leisure time.

However, most sports appliances in the gymnasium are complex in construction and costly in purchase; especial the volume is too bulky, requiring ample space to install and to store as well.

For this reason, the inventor has worked hard for years in research and development and come up with a hand-waving illuminant circlet.

### SUMMARY OF THE INVENTION

The main object of the invention is to provide a hand-waving illuminant circlet rotating in inertial moments. It not only helps maintain good health, but also renders a fantastic glare in playing.

Another object of the invention is to provide a hand-waving illuminant circlet with simple construction, compact structure and ease to play that is highly economical and practicable. It brings forth no ear-splitting noise in practice.

The features and technical advantages are explained in great details with the aid of preferable embodiments as illustrated in the attached drawings.

### BRIEF DESCRIPTION OF THE DRAWINGS

FIG. 1 shows the stereo outlook of the hand-waving illuminant circlet of the invention.

FIG. 2 is the disassembly of the hand-waving illuminant circlet of the invention.

FIG. 3 is a cross section of part 3-3 from FIG. 1

FIG. 4 is the vertical stereo outlook of the hand-waving illuminant circlet of the invention.

FIG. 5 shows the circlet of the invention is in dynamic waving position.

### DETAILED DESCRIPTION OF THE PREFERRED EMBODIMENT

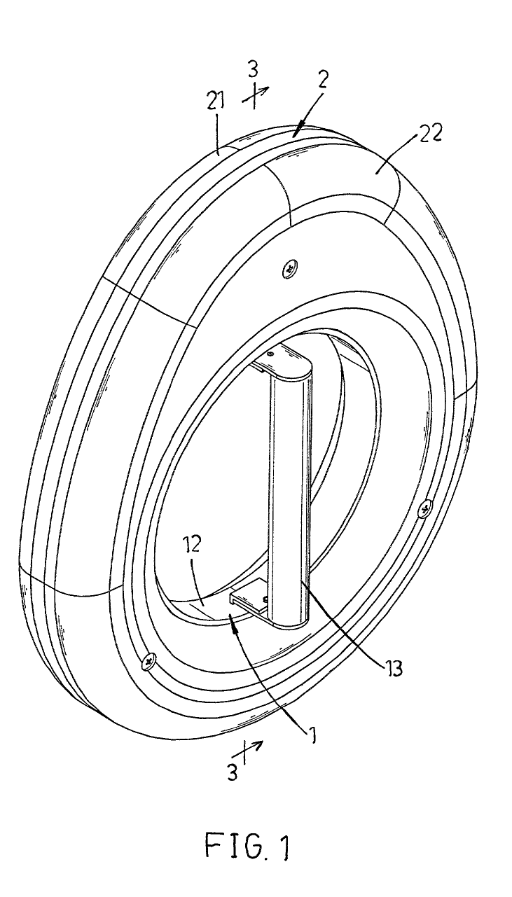

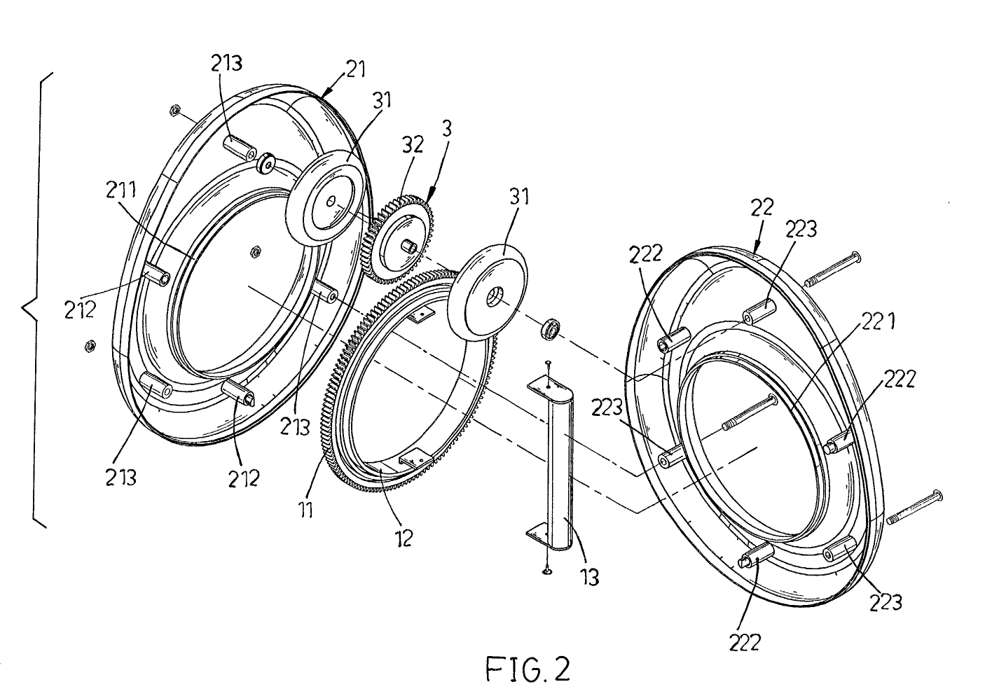

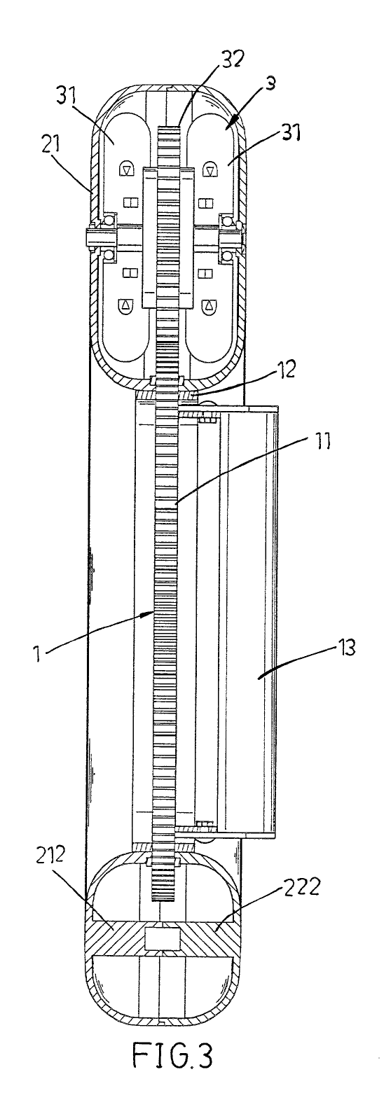

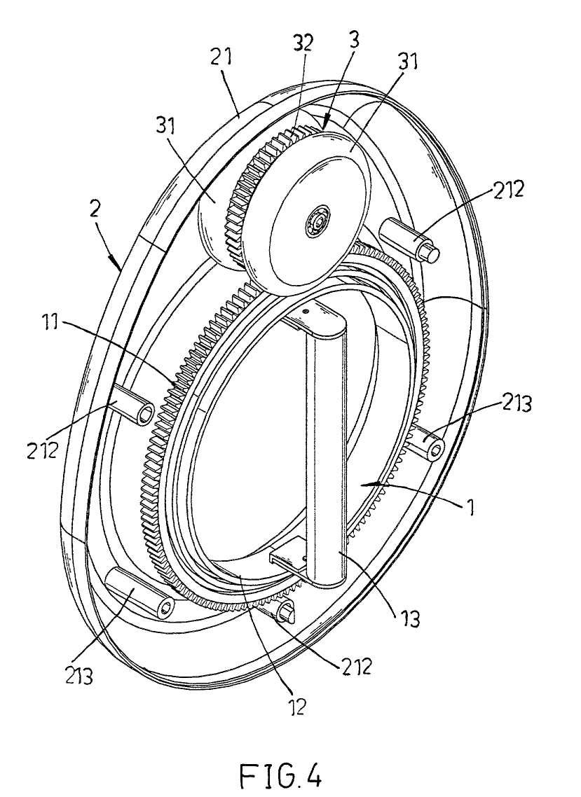

As shown-in FIGS. 1 through 4, the hand-waving illuminant circlet of the invention mainly comprises a cylindrical collar 1, a rotary hub 2 and at least a loaded illuminant element 3 in which the cylindrical collar 1 and the loaded illuminant element 3 are enclosed in the rotary hub 2.

The cylindrical collar 1 is a hollow ring whose outer flange forms a ring gear 11 at the outer perimeter and the flange at the inner rim with an extension 12 for receiving the handle 13.

The rotary hub 2 is composed of a pair of symmetric disks 21, 22 in a completely similar pattern. The disks 21, 22 provide clamp rails 211, 221, the snap posts 212, 222 and snap sockets 213, 223 where the lock bolts will go through the snap sockets 213, 223 and the snap posts 212, 222 to lock two disks 21, 22 together in place. Where the clamp rails 211, 221 will interlock the extension 12 of the cylindrical collar 1 so that the ring gear 11 sits stably in place and meshes to the spur gear 32 of the loaded illuminant element 3 within the rotary hub 2.

The loaded illuminant element 3 is constituted of two illuminant wheels 31 and a spur gear 32 which is sandwiched by two illuminant wheels 31. Two illuminant wheels 31 and the spur gears 32 are fastened on the rotary hub 2 by an axle. The spur gear 32 meshes on the ring gear 11 of the cylindrical collar 1 and the illuminant wheels 31 will produce glare while rotating.

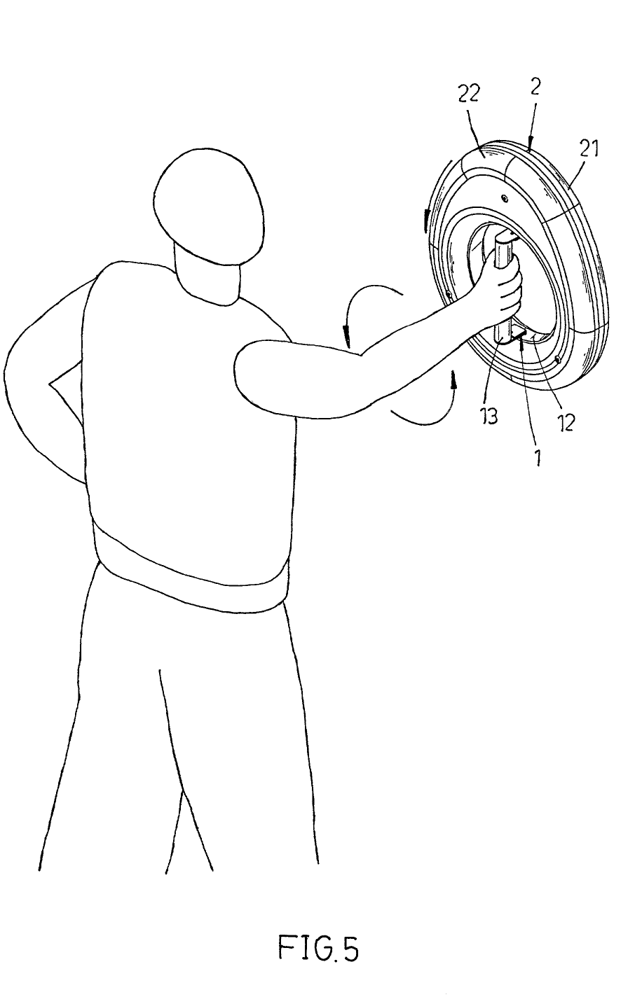

As shown in FIG. 5, as the player holds the lift handle 13 and waves the circlet in the air, the rotary hub 2 begins to rotate, the disk 21, 21 designed in an eccentric pattern move with a moment of inertia, and the loaded illuminant element 3 produces a centrifugal force which keeps the rotary hub 2 rotating. When the player waves the lift handle 13 in an orbit, the loaded illuminant element 3 continues circumnavigating along the ring gear 11 and the illuminant wheels 31 are emitting a fantastic glare along the orbit.

Viewing from the above statement, it is apparent that the hand-waving illuminant circlet is really a novel product with a simple structure, which can train and strengthen the arm muscle effectively, so it is reasonably justified to be granted a new patent.

What the invention claimed is:

1. A hand-waving illuminant circlet, mainly comprising a cylindrical collar, a rotary hub and at least a loaded illuminant element characterized by:
said cylindrical collar fastening a handle at an inner rim and forming a ring gear on a perimeter;
said rotary hub constituting two symmetric disks having a clamp rail formed at an inner perimeter and a plurality of snap posts and snap sockets for locking tow disks together to become an integral rotary hub, said clamp rail providing a circumferential groove for said ring gear of said cylindrical collar to sit on and rotate around;
at least a loaded illuminant element consisting of two illuminant wheels and a spur gear sandwiched by two illuminant wheels, said illuminant wheels and said spur gear anchored on said rotary hub and said spur gears meshing on said ring gear for rotation.
when a player holding and waving said handle in the air, disks of said rotary hub beginning rotating and producing an eccentric moment of inertia, forcing said loaded illuminant element to be effected a centrifugal force keeping said rotary hub in ceaseless rotation, when said player moving said circlet in an orbit, said loaded illuminant element continuing circumnavigating along said ring gear by dint of a moment of inertia and emitting fantastic glare as said player waves.
